(19) United States
(12) Patent Application Publication
(10) Pub. No.: US 2012/0122415 A1
(43) Pub. Date: May 17, 2012

(54) WIRELESS COMMUNICATION DEVICE AND SIGNAL DETECTING METHOD

(75) Inventor: Hideki Saitoh, Kanagawa (JP)

(73) Assignees: NEC CASIO MOBILE COMMUNICATIONS, LTD., Kanagawa (JP); PANASONIC CORPORATION, Osaka (JP)

(21) Appl. No.: 13/387,074

(22) PCT Filed: Jul. 26, 2010
(86) PCT No.: PCT/JP2010/004745

§ 371 Date: Jan. 25, 2012

(30) Foreign Application Priority Data
Jul. 29, 2009 (JP) 2009-176759

(51) Int. Cl. H04B 1/10

(52) U.S. Cl. 455/296

(57) ABSTRACT

Disclosed is a wireless communication device capable of improving the properties of an interference canceller and improving reception performance without increase in circuit scale and without increase in power consumption. In the device, a channel estimation unit (301) obtains the channel estimation value of each path and the dispersion value of the channel estimation value for each cell from a received signal subjected to multipath phasing. A channel power calculation unit (303) calculates the cell-based power sum of the power of the channel estimation value of each path. A received signal power calculation unit (304) calculates the received power of the received signal. An index calculation unit (305) calculates a thermal noise power index on the basis of the channel estimation value, the dispersion value, the power sum, and the received power, and calculates the received power index of an interference cell on the basis of the channel estimation value, the dispersion value, and the received power.

### TECHNICAL FIELD

The present invention relates to a radio communication device and a signal detecting method, and more particularly, relates to a radio communication device having an interference canceller that eliminates an interference component of an interference cell from a received signal, and to a signal detecting in ethod.

### BACKGROUND ART

Conventionally, a CDMA high-speed communication system such as High Speed Downlink Packet Access (HSDPA) is known. In such a CDMA high-speed communication system, a CDMA receiver is excellent in communication quality and can perform communications at a high rate in a case where it performs communications in the vicinity of a base station. On the other hand, in a case where the CDMA receiver performs communications at a cell edge away from a base station, interference from an adjacent cell is significant, and an available rate for communications is restricted to be low.

Conventionally, as a CDMA receiver is known one that uses an interference canceller that eliminates a signal of another cell as an interference cell to prevent a decrease in rate at a cell edge for the purpose of improvement in receiving performance (for example, see Patent Literature 1 and Patent Literature 2). In order to eliminate the signal of the interference cell with use of the interference canceller, channel estimation of the interference cell needs to be performed, and received power and thermal noise power of the interference cell need to be accurately derived.

Also, a method for estimating received power of another cell as an interference cell by estimating all spreading codes used in another cell is conventionally known (for example, Patent Literature 3).

### CITATION LIST

### Patent Literature

PTL 1
Japanese Patent Application Laid-Open No.2005-328311
PTL 2
Japanese Patent Application Laid-Open No.2006-54900
PTL 3
U.S. Pat. No.6,956,893

### SUMMARY OF INVENTION

### Technical Problem

However, in Patent Literature 1 and Patent Literature 2, thermal noise power containing both the received power and the thermal noise power of the interference cell is estimated, and correct thermal noise power cannot be calculated, which causes a problem of a decrease in performance of the interference canceller. Also, in Patent Literature 3, since the received power of the interference cell can be estimated, the thermal noise power can be accurately derived by removing the received power of the interference cell derived by a method in Patent Literature 3 from the thermal noise power derived by a method in Patent Literature 1 or Patent Literature 2. However, in Patent Literature 3, multiple desp eaders are required, which causes a problem of enlargement of a circuit size and an increase in power consumption.

It is therefore an object of the present invention to provide a radio communication device and a signal detecting method enabling to improve characteristics of an interference canceller and receiving performance without enlarging a circuit size or increasing power consumption.

### Solution to Problem

A radio communication device according to the present invention is configured to include a channel estimating section that derives a channel estimating value and a variance value of the channel estimating value for each path per cell from received signals subjected to multipath fading, a power sum calculating section that calculates a power sum per cell of power of the channel estimating value for each path, a received power calculating section that calculates received power of the received signals, a factor calculating section that calculates a thermal noise power factor based on the channel estimating value, the variance value, the power sum, and the received power and calculates a received power factor of an interference cell based on the channel estimating value, the variance value, and the received power, and an interference cancelling section that eliminates an interference component of the interference cell contained in the received signals by filtering the received signals by a filter coefficient derived from the thermal noise power factor and the received power factor of the interference cell.

A signal detecting method according to the present invention is a signal detecting method in a radio communication device eliminating an interference component of an interference cell from received signals to detect signals of a desired cell and includes a step of deriving a channel estimating value and a variance value of the channel estimating value for each path per cell from the received signals subjected to multipath fading, a step of calculating a power sum per cell of power of the channel estimating value for each path, a step of calculating received power of the received signals, a step of calculating a thermal noise power factor based on the channel estimating value, the variance value, the power sum, and the received power and calculating a received power factor of the interference cell based on the channel estimating value, the variance value, and the received power, and a step of detecting signals from which the interference component of the interference cell contained in the received signals is eliminated by filtering the received signals by a filter coefficient derived from the thermal noise power factor and the received power factor of the interference cell.

### Advantageous Effects of Invention

With the present invention, it is possible to improve characteristics of an interference canceller and improve receiving performance without enlarging a circuit size or increasing power consumption.

### BRIEF DESCRIPTION OF DRAWINGS

FIG. 1 shows a communication system according to Embodiment 1 of the present invention;

FIG. 2 is a block diagram showing a configuration of a radio communication device according to Embodiment 1 of the present invention;

FIG. 3 is a block diagram showing a configuration of a demodulating section according to Embodiment 1 of the present invention;

FIG. 4 is a flowchart showing operations of the demodulating section according to Embodiment 1 of the present invention;

FIG. 5 is a spectral schematic diagram after CDMA despreading processing according to Embodiment 1 of the present invention; and

FIG. 6 is a block diagram showing a configuration of a demodulating section according to Embodiment 2 of the present invention.

### DESCRIPTION OF EMBODIMENTS

Now, embodiments of the present invention will be described in detail with reference to the accompanying drawings.

### Embodiment 1

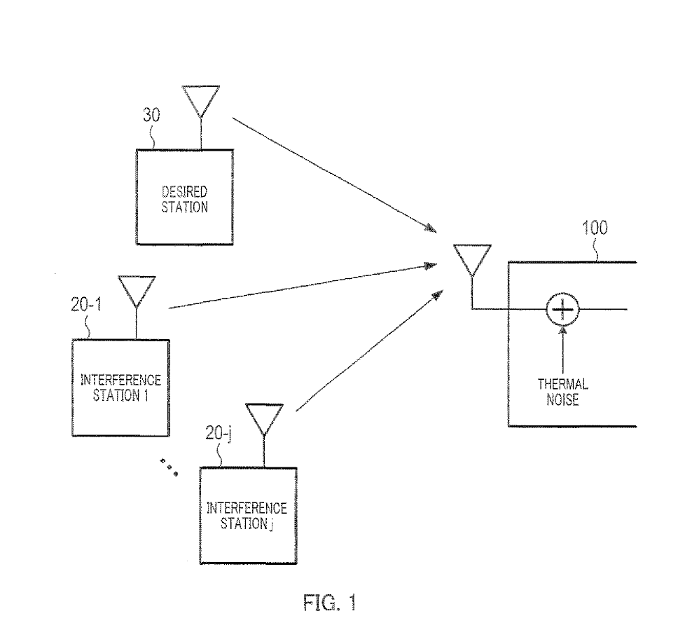

FIG. 1 shows a configuration of a communication system according to Embodiment of the present invention.

In FIG. 1, the communication system according to the present embodiment is mainly configured to include plural interference stations 20-1 to 20-j (j is an arbitrary natural number representing the number of interference stations), desired station 30, and radio communication device 100 such as a cell phone.

In FIG. 1, interference stations 20-1 to 20-j constitute adjacent cells to desired station 30. Wireless communication device 100 performs communications with desired station 30 in a cell of desired station 30. At this time, radio communication device 100 receives signals from desired station 30 as well as from interference stations 20-1 to 20-j.

Accordingly, by accurately eliminating from received signals interference components by interference stations 20-1 to 20-j contained in the received signals, radio communication device 100 can accurately detect signals of desired station 30.

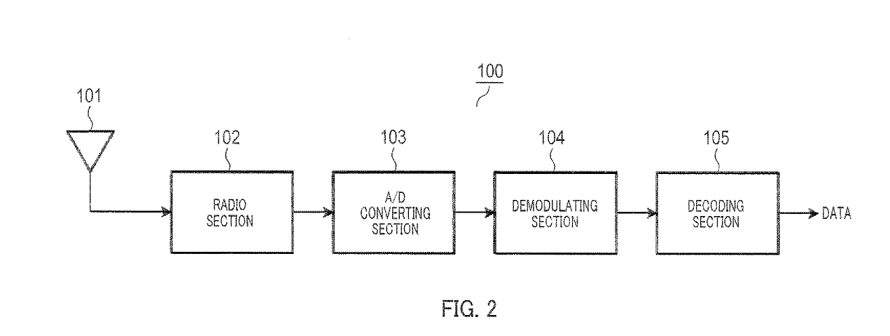

Next, a configuration of radio communication device 100 will be described with reference to FIG. 2. FIG. 2 is a block diagram showing a configuration of radio communication device 100. Wireless communication device 100 is, for example, a CDMA receiver.

Wireless communication device 100 is mainly configured to include antenna 101, radio section 102, analog/digital (hereinafter referred to as “AID”) converting section 103, demodulating section 104, and decoding section 105. Hereinafter, each component will be described in details.

Antenna 101 receives CDMA signals transmitted from the desired station and the interference stations, and outputs them to radio section 102.

Wireless section 102 performs filtering processing to each CDMA signal input from antenna 101 with use of a low-pass filter or a band-pass filter. Wireless section 102 then outputs the filter-processed CDMA signal to AID converting section 103.

A/D converting section 103 converts the CDMA signal, which is an analog signal, input from radio section 102 into a digital signal and outputs it to demodulating section 104.

Demodulating section 104 demodulates the digital signal input from A/D converting section 103 and outputs it to decoding section 105. At this time, demodulating section 104 performs processing of eliminating an interference component of an interference cell from the received signal. Details of a configuration of demodulating section 104 will be described later.

Decoding section 105 decodes the demodulated signal input from demodulating section 104 and outputs a decoded result as data.

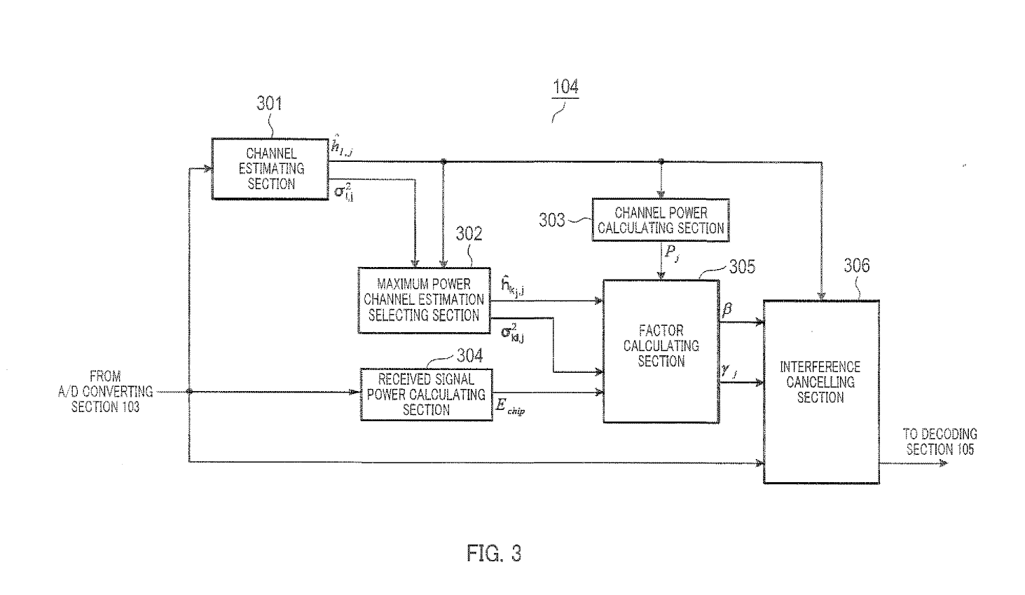

Next, details of a configuration of demodulating section 104 will be described with reference to FIG. 3. FIG. 3 is a block diagram showing a configuration of demodulating section 104.

Demodulating section 104 is mainly configured to include channel estimating section 301, maximum power channel estimation selecting section 302, channel power calculating section 303, received signal power calculating section 304, factor calculating section 305, and interference cancelling section 306. Hereinafter, each component will be described in details.

Channel estimating section 301 calculates channel estimating values and variance values of the channel estimating values for the desired cell (desired station) and the interference cells (interference stations) for respective paths constituting multipath fading from digital signals input from A/D converting section 103. Subsequently, channel estimating section 301′ outputs the calculated channel estimating values for the respective paths to maximum power channel estimation selecting section 302, channel power calculating section 303, and interference cancelling section 306 and outputs the calculated variance values of the channel estimating values for the respective paths to maximum power channel estimation selecting section 302.

Maximum power channel estimation selecting section 302 selects the channel estimating value and the variance value of the channel estimating value for a path having maximum power per cell from among the channel estimating values and the variance values of the channel estimating values for the respective paths input from channel estimating section 301. Subsequently, maximum power channel estimation selecting section 302 outputs the selected channel estimating value and the selected variance value of the channel estimating value for each path to factor calculating section 305.

Channel power calculating section 303 derives power values for the respective paths from the channel estimating values for the respective paths input from channel estimating section 301 and sums the derived power values for the respective paths per cell to calculate a power sum of the channel estimating values for each cell. Subsequently, channel power calculating section 303 outputs the calculated power sum value to factor calculating section 305.

Received signal power calculating section 304 calculates received power of the digital signals input from A/D converting section 103. Subsequently, received signal power calculating section 304 outputs the calculated received power value to factor calculating section 305.

Factor calculating section 305 calculates a thermal noise power factor based on the channel estimating value and the variance value for the path having maximum power input from maximum power channel estimation selecting section 302, the calculated power sum value input from channel power calculating section 303, and the calculated received power value input from received signal power calculating section 304. Factor calculating section 305 also calculates a received power factor of each interference cell based on the channel estimating value and the variance value for the path having maximum power input from maximum power channel estimation selecting section 302 and the calculated received power value input from received signal power calculating section 304. That is, factor calculating section 305 calculates the thermal noise power factor and the received power factor of each interference cell separately. Subsequently, factor calculating section 305 outputs the calculated thermal noise power factor and the calculated received power factor of each interference cell to interference cancelling section 306. It is to be noted that methods for deriving the thermal noise power factor and the received power factor of each interference cell will be described later.

Interference cancelling section 306 restores orthogonality by multipath and performs filtering processing for eliminating the interference component of each interference cell for the digital signals input from AID converting section 103 based on the channel estimating value for each cell input from channel estimating section 301 and the thermal noise power factor and the received power factor of each interference cell input from factor calculating section 305. Subsequently, interference cancelling section 306 outputs the digital signals from which the interference component has been eliminated to decoding section 105 as demodulated signals.

This is the end of the description of the configuration of demodulating section 104.

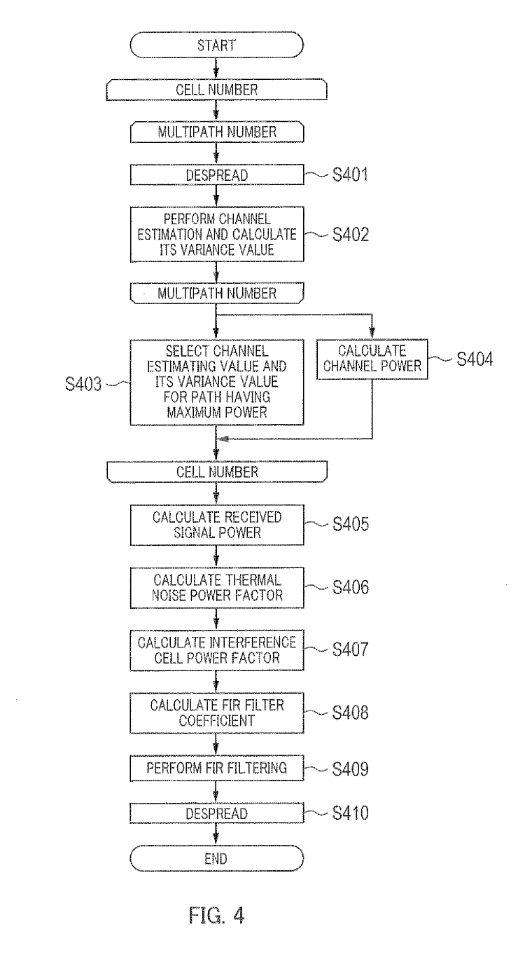

Next, operations of demodulating section 104 will be described with reference to FIG. 4. FIG. 4 is a flowchart showing operations of demodulating section 104.

First, channel estimating section 301 performs despreading processing of the digital signals input from A/D converting section 103 for respective individual paths separable from one another constituting multipath fading (step ST401). At this time, channel estimating section 301 has only to perform despreading of only specific channels such as pilot channels for both the desired cell and the interference cells.

Channel estimating section 301 also calculates the channel estimating values and the variance values of the channel estimating values for the respective paths from despread signals (step ST402). The processing at step ST401 and step ST402 is performed for each path constituting multipath.

Subsequently, maximum power channel estimation selecting section 302 calculates power values of the channel estimating values for the respective paths and selects the channel estimating value and the variance value of the channel estimating value for a path having maximum power among the calculated power values (step ST403).

Channel power calculating section 303 squares the channel estimating values for the respective paths and derives a sum of the squared channel estimating values to calculate channel power (step ST404). The processing at step ST403 and step ST404 is performed for each cell.

Received signal power calculating section 304 squares the digital signals input from A/D converting section 103 and averages the product sums for a predetermined interval to calculate received power of the digital signals (step ST405).

Subsequently, factor calculating section 305 calculates a thermal noise power factor β with use of the channel estimating value and the variance value of the channel estimating value for the path having maximum power per cell, the power sum per cell, and the received power of the received signals. Specifically, factor calculating section 305 calculates the thermal noise power factor β with use of Equation 1 shown below (step ST406). It is to be noted that a reason why the thermal noise power factor can be calculated by Equation 1 will be described later.

$$\begin{matrix}Equation 1 & \\ \begin{matrix}β = \frac{{E}_{c} \cdot {I}_{o c}^{′}}{{\hat{I}}_{{or}_{0}}} \\ = \frac{{\vert {\hat{h}}_{{k}_{0} , 0} \vert}^{2}}{{E}_{chip} - SF \cdot {σ}_{{k}_{0} , 0}^{2}} \\ \{ {E}_{chip} - {\sum }_{1}^{j} \frac{{P}_{j}}{{\vert {{h}^{̑}}_{{k}_{j} , j} \vert}^{2}} ( {E}_{chip} - SF \cdot {σ}_{{k}_{j} , j}^{2} ) \} - {P}_{0}\end{matrix} & [ 1 ]\end{matrix}$$

where Îₒᵣ; is received power for a j-th cell (as for the desired cell, j=0),
I′_{oc} is thermal noise power,
E_{c} is received power for a channel subjected to channel estimation,
ĥ_{i,j} is a channel estimating value for an 1-th multipath of the j-th cell,
σ_{i,j}² is a variance value of the channel estimating value for the 1-th multipath of the j-th cell,
E_{chip} is received power of received signals,
SF is a spreading rate of the channel subjected to channel estimation,

$${P}_{j} = {\sum }_{0}^{L - 1} {\vert {\hat{h}}_{l , j} \vert}^{2}$$

is a channel power value for the j-th cell,
J is the number of interference cells,
kⱼ is a maximum power path index for the j-th cell, and
β is a thermal noise power factor.

Subsequently, factor calculating section 305 calculates a received power factor γj of each interference cell with use of the channel estimating value and the variance value of the channel estimating value for the path having maximum power per cell and the received power of the received signals. Specifically, factor calculating section 305 calculates the received power factor γj of each interference cell with use of Equation 2 shown below (step ST407). It is to be noted that a reason why the received power factor γj of each interference cell can be calculated by Equation 2 will be described later.

$$\begin{matrix}Equation 2 & \\ {γ}_{j} = \frac{{E}_{c} \cdot {\hat{I}}_{{or}_{0}}}{{\hat{I}}_{{or}_{0}}} = \frac{{\vert {\hat{h}}_{{k}_{0} , 0} \vert}^{2} ( {E}_{chip} - SF \cdot {σ}_{{k}_{j} , j}^{2} )}{{\vert {\hat{h}}_{{k}_{j} , j} \vert}^{2} ( {E}_{chip} - SF \cdot {σ}_{{k}_{0} , 0}^{2} )} & [ 2 ]\end{matrix}$$

where Îₒᵣ_{ⱼ} is is received power for a j-th cell (as for the desired cell, j=0),
ĥ_{i,j} is a channel estimating value for an 1-th multipath of the j-th cell,
σ_{i,j}² is a variance value of the channel estimating value for the 1-th multipath of the j-th cell,
E_{c} is received power for a channel subjected to channel estimation,
E_{chip} is received power of received signals,
SF is a spreading rate of the channel subjected to channel estimation,
kⱼ is a maximum power path index for the j-th cell, and
γj is a received power factor of an interference cell as the j-th cell.

Subsequently, interference cancelling section 306 restores orthogonality by multipath and calculates an FIR filter coefficient for eliminating the interference from each interference cell with use of the channel estimating value for each cell, the thermal noise power factor, and the received power factor of each interference cell (step ST408). Specifically, interference cancelling section 306 constructs a matrix as in Equation 3 shown below.

$$\begin{matrix}Equation 3 & \\ G = {H}_{0}^{H} {H}_{0} + {\sum }_{1}^{J} {γ}_{j} {H}_{j}^{H} {H}_{j} + β I & [ 3 ]\end{matrix}$$

where Hj is channel matrix for a j-th cell (as for the desired cell, j=0),
()^{H} is complex conjugate transposition of a matrix,
I is a unit matrix,
β is a thermal noise power factor,
γj is a received power factor of an interference cell as the j-th cell, and
J is the number of interference cells.

Interference cancelling section 306 also calculates a filter coefficient W by Equation 4 shown below.

W=G⁻¹H₀^{H} Equation 4

where ()^{H} is complex conjugate transposition of a matrix,and.
W is a filter coefficient.

Interference cancelling section 306 also performs FIR filtering for the digital signals input from A/D converting section 103 with use of the calculated filter coefficient (step ST409).

Interference cancelling section 306 then performs despreading processing of the FIR-filtered signals (step ST410). At this time, interference cancelling section 306 does not perform despreading processing for each interference cell.

Subsequently, interference cancelling section 306 outputs the signals undergoing the despreading processing to decoding section 105 as demodulated signals. This is the end of the description of the operations of demodulating section 104.

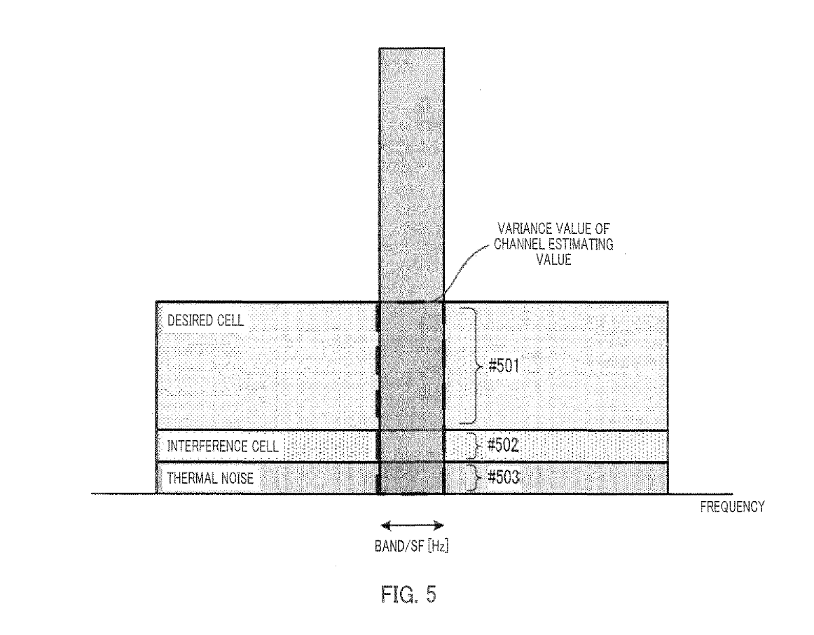

Next, the reason why the thermal noise power factor β can be calculated by Equation. I and the reason why the received power factor γj of each interference cell can be calculated by Equation 2 will be described with reference to FIG. 5. FIG. 5 is a spectral schematic diagram after CDMA despreading processing.

First, Equation (5) which is a model equation for a received signal r (n) at time n in consideration of interference cells, is set.

$$\begin{matrix}Equation 5 & \\ r ( n ) = {\sum }_{i = 0}^{L - 1} {h}_{l , 0} {s}_{0} ( n - {τ}_{l , 0} ) + {\sum }_{j = 1}^{J} {\sum }_{l = 0}^{L - 1} {h}_{l , j} {s}_{j} ( n - {τ}_{l , j} ) + v ( n ) & [ 5 ]\end{matrix}$$

where sⱼ(n) is a send signal of j-th cell,
τ_{i,j}is a delay time of the first multipath of j-th cell,
v(n) is a thermal noise,
r(n) is a received signal,
n is a time,
J is the number of interference cells, and
L is the number of multipaths (each cell shall have the equal number of multipaths for simplification).

When both sides of Equation 5 are squared, Equation 6, which is a model equation for received power of the received signal, is obtained.

$$\begin{matrix}Equation 6 & \\ {E}_{chip} = {\sum }_{l = 0}^{L - 1} {\vert {h}_{l , 0} \vert}^{2} {\hat{I}}_{{or}_{0}} + {\sum }_{j = 1}^{J} {\sum }_{l = 0}^{L - 1} {\vert {h}_{l , j} \vert}^{2} {\hat{I}}_{{or}_{j}} + {I}_{oc}^{′} & [ 6 ]\end{matrix}$$

where Î_{of}_{ᵤ} is a received signal from the desired cell,
Îₒᵣ_{ⱼ}(j=1, . . . , J) is received power from the interference cells,
I′_{oc} is thermal noise power,

E_{chip} is received power of the received signals,
J is the number of interference cells, and
L is the number of multipaths (each cell shall have the equal number of multipaths for simplification).

Subsequently, a variance model equation for a channel estimating value in consideration of interference cells is set. As shown in FIG. 5, in a case where despreading processing and channel estimation are performed for each path of multipaths in the desired cell, variance of the channel estimating value contains interference #501 from the other paths in the desired cell, interference #502 from the interference cells, and a thermal noise component #503. A variance model equation for this channel estimating value is as in Equation 7 shown below.

$$\begin{matrix}Equation 7 & \\ {σ}_{l , 0}^{2} = \frac{1}{SF} ( {\sum }_{l = 0 , l \neq k}^{L - 1} {\vert {h}_{l , 0} \vert}^{2} {\hat{I}}_{{or}_{0}} + {\sum }_{j = 1}^{J} {\sum }_{l = 0}^{L - 1} {\vert {h}_{l , j} \vert}^{2} {\hat{I}}_{{or}_{j}} + {I}_{oc}^{′} ) & [ 7 ]\end{matrix}$$

where Î_{of}_{ₙ} is received power from the desired cell,
Îₒᵣ_{ⱼ}(j=1, . . . , J) is received power from the interference cells,
I′_{oc} is thermal noise power,
SF is a spreading rate of a channel subjected to channel estimation,
J is the number of interference cells, and
L is the number of multipaths (each cell shall have the equal number of multipaths for simplification).

Similarly, as many variance model equations for channel estimating values as the number of interference cells (J pieces) in a case where despreading processing and channel estimation are performed for each path of multipaths in each of the interference cells are set.

In Equation 6 and as many Equations 7 as (J+1), unknowns are (J+2) values, which are received power from the desired cell, received power from the interference cells, and thermal noise power. Accordingly, the thermal noise power and the received power of the interference cells can be calculated by solving a linear equation with (J+2) unknowns. With use of these, the thermal noise power factor β can be calculated by Equation 1, and the received power factor γj of each interference cell can be calculated by Equation 2.

In the present embodiment, signals are received by one antenna. However, the embodiment is not limited to this, and signals may be received by plural antennae. In this case, the thermal noise power factor and the received power factor of each interference cell can be calculated per antenna. Also, by averaging the thermal noise power factors and the received power factors of each interference cell calculated per antenna among the antennae, the thermal noise power factor and the received power factor of each interference cell can be calculated more accurately.

Thus, with the present embodiment, by estimating the thermal noise power factor and the received power factor of each interference cell separately, estimation accuracy of the thermal noise power can be improved, characteristics of the interference canceller can be improved, and receiving performance can he improved. Also, with the present embodiment, despreading, processing has only to be performed only for specific channels such as pilot channels for the interference cells. Accordingly, a circuit size can be restricted, and power consumption can be decreased.

### Embodiment 2

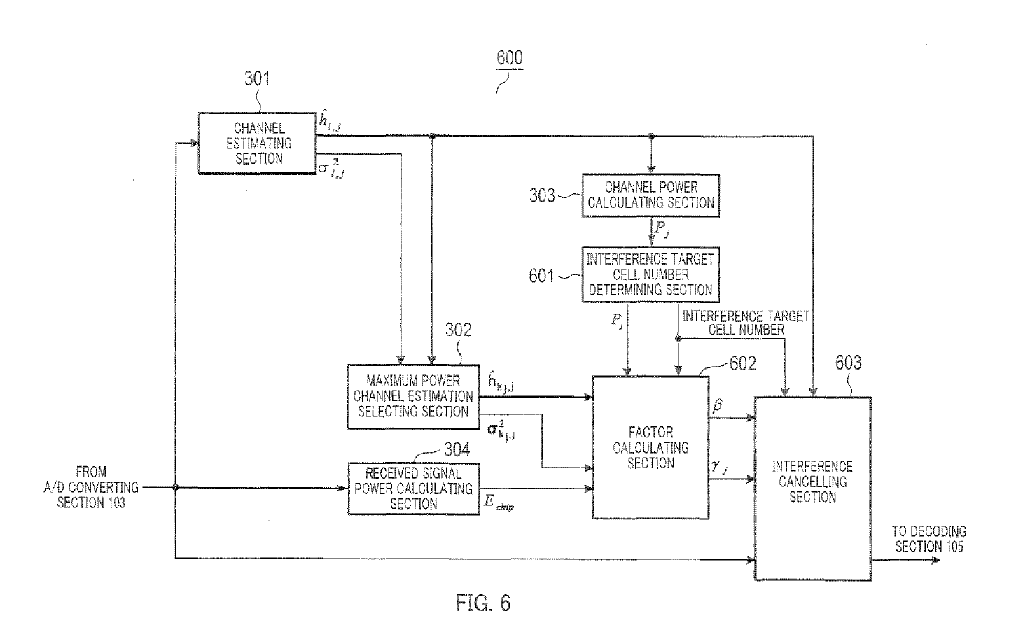

FIG. 6 is a block diagram showing a configuration of demodulating section 600 according to Embodiment 2 of the present invention.

In comparison with demodulating section 104 according to Embodiment 1 shown in FIG. 3, demodulating section 600 shown in FIG. 6 is provided with interference target cell number determining section 601, has factor calculating section 602 instead of factor calculating section 305, and has interference cancelling section 603 instead of interference cancelling section 306. It is to be noted that identical components to those in FIG. 3 are denoted with the same reference numerals, and a description of the duplicate components is omitted. Also, in the present embodiment, since a configuration of a communication system is identical to FIG. 1, and a configuration of a radio communication device is identical to FIG. 2 except for having demodulating section 600 instead of demodulating section 104, descriptions thereof are omitted.

Channel estimating section 301 calculates channel estimating values and variance values of the channel estimating values for the desired cell (desired station) and the interference cells (interference stations) for respective paths constituting multipath fading from digital signals input from AID converting section 103. Subsequently, channel estimating section 301 outputs the calculated channel estimating values for the respective paths to maximum power channel estimation selecting section 302, channel power calculating section 303, and interference cancelling section 603 and outputs the calculated variance values of the channel estimating values for the respective paths to maximum power channel estimation selecting section 302.

Maximum power channel estimation selecting section 302 selects the channel estimating value and the variance value of the channel estimating value for a path having maximum power per cell from among the channel estimating values and the variance values of the channel estimating values for the respective paths input from channel estimating section 301. Subsequently, maximum power channel estimation selecting section 302 outputs the selected channel estimating value and the selected variance value of the channel estimating value for each path to factor calculating section 602.

Received signal power calculating section 304 calculates received power of the received signals input from A/D converting section 103. Subsequently, received signal power calculating section 304 outputs the calculated received power value to factor calculating section 602.

Channel power calculating section 303 derives power values for the respective paths from the channel estimating values for the respective paths input from channel estimating section 301 and sums the derived power values for the respective paths per cell to calculate a power sum of the channel estimating values for each cell. Subsequently, channel power calculating section 303 outputs the calculated power sum value to interference target cell number determining section 601.

Interference target cell number determining section 601 outputs the calculated power sum value input from channel power calculating section 303 in a case where the input power sum is larger than a threshold value. Interference target cell number determining section 601 does not output the calculated power sum value input from channel power calculating section 303 in a case where the input power sum is a threshold value or less. Also, interference target cell number determining section 601 counts cells having a larger calculated power sum value than the threshold value as interference target cells. Subsequently, interference target cell number determining section 601 outputs the counted value as an interference target cell number to factor calculating section 602 and interference cancelling section 603.

Factor calculating section 602 calculates a thermal noise power factor and a received power factor of each interference cell based on the channel estimating value and the variance value for the path having maximum power input from maximum power channel estimation selecting section 302, the calculated power sum value input from interference target cell number determining section 601, and the calculated received power value input from received signal power calculating section 304. At this time, factor calculating section 602 calculates the thermal noise power factor and the received power factor of each interference cell by calculation excluding cells other than the interference target cells based on the interference target cell number input from interference target cell number determining section 601. Subsequently, factor calculating section 602 outputs the calculated thermal noise power factor and the calculated received power factor of each interference cell to interference cancelling section 603.

Interference cancelling section 603 restores orthogonality by multipath and performs filtering processing for eliminating the interference component of each interference cell for the digital signals input from A/D converting section 103 based on the channel estimating value for each cell input from channel estimating section 301 and the thermal noise power factor and the received power factor of each interference cell input from factor calculating section 602. At this time, interference cancelling section 603 does not eliminate interference of cells other than. the interference target cells based on the interference target cell number input from interference target cell number determining section 601. Subsequently, interference cancelling section 603 outputs the digital signals from which the interference component has been eliminated to decoding section 105 as demodulated signals.

Meanwhile, since operations of demodulating section 600 are identical to those in FIG. 4 except for performing calculation and processing by excluding cells other than the interference target cells, a description thereof is omitted. Also, in the present embodiment as well as in Embodiment 1 described above, signals may be received by plural antennae.

Thus, with the present embodiment, since the received power factor of a cell of which calculated power sum value is the threshold value or less and which is not an interference target is not calculated, and signal detection for a cell which is not an interference target is not performed, power consumption can be further decreased in addition to the effect of Embodiment I described above.

The disclosure of Japanese Patent Application No. 2009-176759, filed on Jul. 29, 2009, including the specification, drawings and abstract, is incorporated herein by reference in its entirety.

### INDUSTRIAL APPLICABILITY

The radio communication device and the signal detecting method according to the present invention are suitable especially for eliminating an interference component of an interference cell from a received signal by an interference canceller.

1. A radio communication device comprising:
a channel estimating section that derives a channel estimating value and a variance value of the channel estimating value for each path per cell from received signals subjected to multipath fading;
a power sum calculating section that calculates a power sum per cell of power of the channel estimating value for each path;
a received power calculating section that calculates received power of the received signals;
a factor calculating section that calculates a thermal noise power factor based on the channel estimating value, the variance value, the power sum, and the received power and calculates a received power factor of an interference cell based on the channel estimating value, the variance value, and the received power; and
an interference cancelling section that eliminates an interference component of the interference cell contained in the received signals by filtering the received signals by a filter coefficient derived from the thermal noise power factor and the received power factor of the interference cell.

2. The radio communication device according to claim 1, wherein the factor calculating section calculates the received power factor of the interference cell of cell whose power sum is a threshold value or more.

3. The radio communication device according to claim 1, wherein the factor calculating section calculates the thermal noise power factor by Equation 1.
$$\begin{matrix}Equation 1 & \\ \begin{matrix}β = \frac{{E}_{c} \cdot {I}_{o c}^{′}}{{\hat{I}}_{{or}_{0}}} \\ = \frac{{\vert {\hat{h}}_{{k}_{0} , 0} \vert}^{2}}{{E}_{chip} - SF \cdot {σ}_{{k}_{0} , 0}^{2}} \\ \{ {E}_{chip} - {\sum }_{1}^{J} \frac{{P}_{j}}{{\vert {\hat{h}}_{{k}_{j} , j} \vert}^{2}} ( {E}_{chip} - SF \cdot {σ}_{{k}_{j} , j}^{2} ) \} - {P}_{0}\end{matrix} & [ 1 ]\end{matrix}$$
where is received power for a j-th cell (as for the desired cell, j=0),
I′_{oc} is is thermal noise power,
E_{c} is received power for a channel subjected to channel estimation,
ĥ_{i,j} is a channel estimating value for an 1-th multipath of the j-th cell,
σ_{i,j}² is a variance value of the channel estimating value for the 1-th multipath of the j-th cell,
E_{chip} is received power of received signals,
SF is a spreading rate of the channel subjected to channel estimation,
$${P}_{j} = {\sum }_{0}^{L - 1} {\vert {\hat{h}}_{l , j} \vert}^{2}$$
is a channel power value for the j-th cell,
J is the number of interference cells,
L is the number of multipaths (each cell shall have the equal number of multipaths for simplification),
kⱼ is a maximum power path index for the j-th cell, and
β is a thermal noise power factor.

4. The radio communication device according to claim 1, wherein the factor calculating section calculates the received power factor of the interference cell by Equation (2).
$$\begin{matrix}Equation 2 & \\ {γ}_{j} = \frac{{E}_{c} \cdot {\hat{I}}_{{or}_{0}}}{{\hat{I}}_{{or}_{0}}} = \frac{{\vert {\hat{h}}_{{k}_{0} , 0} \vert}^{2} ( {E}_{chip} - SF \cdot {σ}_{{k}_{j} , j}^{2} )}{{\vert {\hat{h}}_{{k}_{j} , j} \vert}^{2} ( {E}_{chip} - SF \cdot {σ}_{{k}_{0} , 0}^{2} )} & [ 2 ]\end{matrix}$$
where Îₒᵣ_{ⱼ} is received power for a j-th cell (as for the desired cell, j=0),
ĥ_{i,j} is a channel estimating value for an 1-th multipath of the j-th cell,
σ_{i,j}² is a variance value of the channel estimating value for the 1-th multipath of the j-th cell,
E_{c} is received power for a channel subjected to channel estimation,
E_{chip} is received power of received signals,
SF is a spreading rate of the channel subjected to channel estimation,
J is the number of interference cells
kⱼ is a maximum power path index for the j-th cell, and
γj is a received power factor of an interference cell as the j-th cell.

5. The radio communication device according to claim 1, further comprising a receiving section that receives the received signals by a plurality of antennae,
wherein the factor calculating section calculates the thermal noise power factor per antenna.

6. The radio communication device according to claim 1, further comprising a receiving section that receives the received signals by a plurality of antennae,
wherein the factor calculating section calculates the received power factor of the interference cell per antenna.

7. A signal detecting method in a radio communication device eliminating an interference component of an interference cell from received signals to detect signals of a desired cell, comprising:
a step of deriving a channel estimating value and a variance value of the channel estimating value for each path per cell from the received signals subjected to multipath fading;
a step of calculating a power sum per cell of power of the channel estimating value for each path;
a step of calculating received power of the received signals;
a step of calculating a thermal noise power factor based on the channel estimating value, the variance value, the power sum, and the received power and calculating a received power factor of the interference cell based on the channel estimating value, the variance value, and the received power; and
a step of detecting signals from which the interference component of the interference cell contained in the received signals is eliminated by filtering the received signals by a filter coefficient derived from the thermal noise power factor and the received power factor of the interference cell.
